(19) United States
(12) Patent Application Publication
(10) Pub. No.: US 2024/0302559 A1
(43) Pub. Date: Sep. 12, 2024

(54) Floatable Support for Metal Detection

(71) Applicant: Treasure Targets LLC, Grand Junction, CO (US)

(72) Inventors: Tommy J. Smith, Grand Junction, CO (US); Paul William Anthony, Grand Junction, CO (US)

(73) Assignee: Treasure Targets LLC, Grand Junction, CO (US)

(21) Appl. No.: 18/601,819

(22) Filed: Mar. 11, 2024

Related U.S. Application Data
(60) Provisional application No. 63/489,206, filed on Mar. 9, 2023.

(51) Int. Cl. G01V 3/15; B07B 1/46

(52) U.S. Cl. CPC G01V 3/15; B07B 1/469

(57) ABSTRACT

The embodiments of the Floatable Support for Metal Detection are comprised of a circular or oval support, a screen, and a pair of skids. The circular or oval support comprises a tube or cylinder formed from durable and highly puncture resistant polymeric material. The screen comprises a non-metallic, fabric, or polymeric mesh that forms apertures of ½-inch diameter arranged uniformly over the entire screen. The pair of skids are comprised of essentially an isosceles trapezoid. The skids are affixed to the bottom of the circular or oval support to provide a low friction surface to slide the Floatable Support for Metal Detection.

### STATEMENT REGARDING FEDERALLY SPONSORED RESEARCH OR DEVELOPMENT

Not applicable

### FIELD OF THE EMBODIMENTS

The field of the embodiments is accessories for the practice of locating metallic objects using a metal detector.

### BACKGROUND OF THE EMBODIMENTS

Metal detection is a popular vocation and avocation for many people. When metal detection is practiced, a user commonly requires a portable workspace to contain equipment. Furthermore, that portable workspace also serves as a depository to keep items found through the practice of metal detection.

### SUMMARY OF THE EMBODIMENTS

The embodiments of the Floatable Support for Metal Detection are comprised of a circular or oval support, a screen, and a pair of skids. The circular or oval support comprises a tube or cylinder formed from durable and highly puncture resistant polymeric material. The screen is comprised of a non-metallic, fabric, or polymeric mesh that forms apertures of ½-inch diameter arranged uniformly over the entire screen. The pair of skids are comprised of essentially an isosceles trapezoid. The skids are affixed to the bottom of the circular or oval support to provide a low friction surface to slide the Floatable Support for Metal Detection.

There has thus been outlined, rather broadly, the more important features of the embodiments in order that the detailed description thereof that follows may be better understood, and in order that the present contribution to the art may be better appreciated. There are, of course, additional features of the embodiments that will be described hereinafter and which will form the subject matter of the claims appended hereto.

In this respect, before explaining at least one embodiment of the embodiments in detail, it is to be understood that the embodiment is not limited in this application to the details of construction and to the arrangements of the components set forth in the following description or illustrated in the drawings. The embodiment or embodiments are capable of other embodiments and of being practiced and carried out in various ways. Also, it is to be understood that the phraseology and terminology employed herein are for description of sample embodiments only and should not be regarded as limiting. As such, those skilled in the art will appreciate that the conception, upon which this disclosure is based, may readily be used as a basis for the designing of other structures, methods and systems for carrying out the several purposes of the embodiments. Additional benefits and advantages of the embodiments will become apparent in those skilled in the art to which the present embodiments relate from the subsequent description of the preferred embodiment and the appended claims, taken in conjunction with the accompanying drawings. It is important, therefore, that the claims be regarded as including such equivalent constructions insofar as they do not depart from the spirit and scope of the embodiments.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the embodiments of the application which is measured by the claims, nor is it intended to be limiting as to the scope of the embodiments in any way.

### BRIEF DESCRIPTION OF THE DRAWINGS

FIG. 1A is a top view of an embodiment of the Floatable Support for Metal Detection;

FIG. 1B is a sectional view of an embodiment of the Floatable Support for Metal Detection;

FIG. 1C is a sectional view of an embodiment of the Floatable Support for Metal Detection.

FIG. 2A is a top view of an embodiment of a mirror image half of an oval support for the Floatable Support for Metal Detection;

FIG. 2B is a side view of an embodiment of a mirror image half of an oval support for the Floatable Support for Metal Detection;

FIG. 2C is a front view of an embodiment of a mirror image half of an oval support for the Floatable Support for Metal Detection.

FIG. 3A is a top view of an embodiment of the screen for the Floatable Support for Metal Detection;

FIG. 3B is a side view of an embodiment of the screen for the Floatable Support for Metal Detection;

FIG. 3C is a front view of an embodiment of the screen for the Floatable Support for Metal Detection.

FIG. 4A is a top view of an embodiment of a mirror image half of an oval support with the screen for the Floatable Support for Metal Detection;

FIG. 4B is a side view of an embodiment of a mirror image half of an oval support with the screen for the Floatable Support for Metal Detection;

FIG. 4C is a front view of an embodiment of a mirror image half of an oval support with the screen for the Floatable Support for Metal Detection.

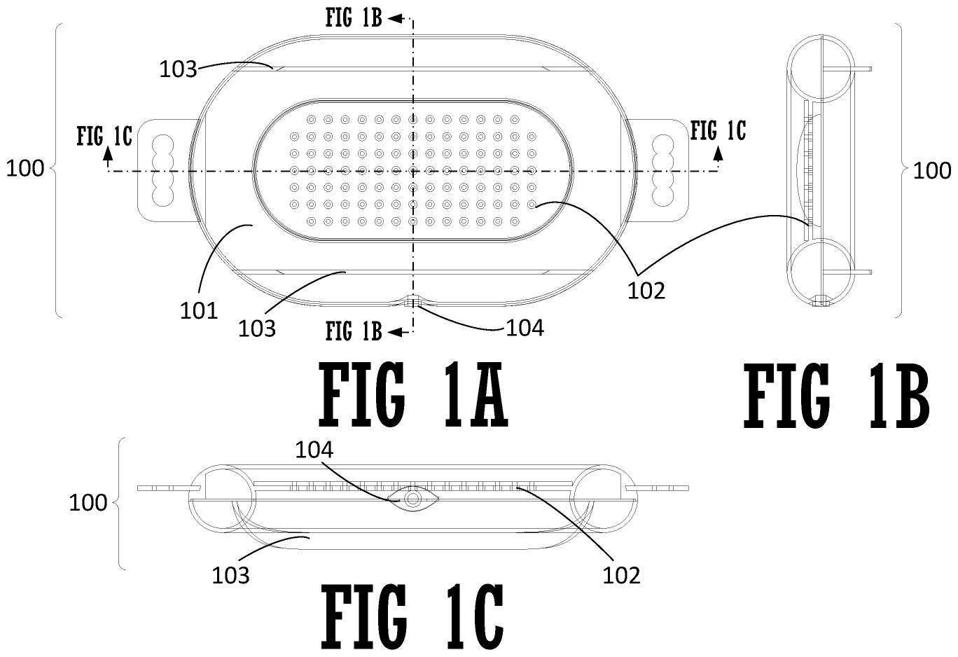

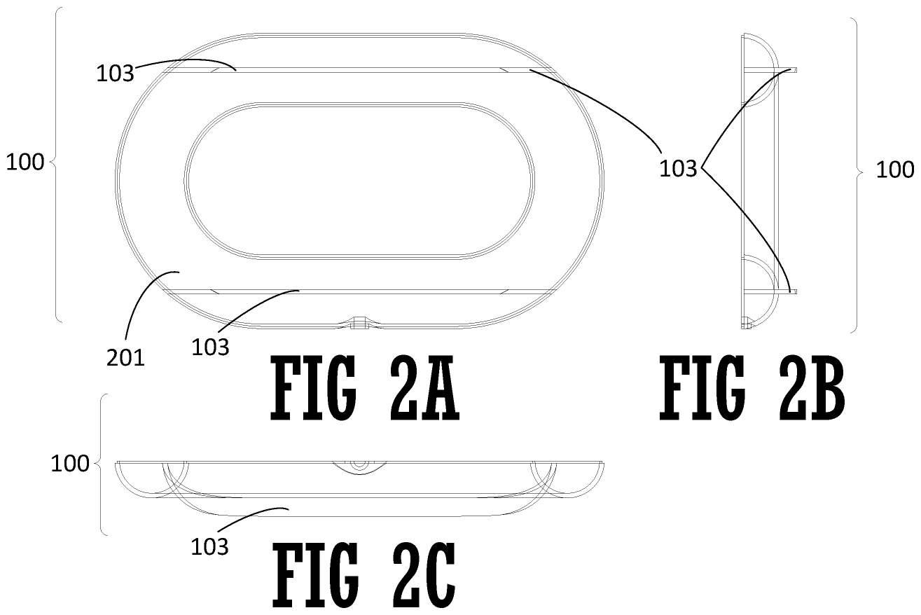

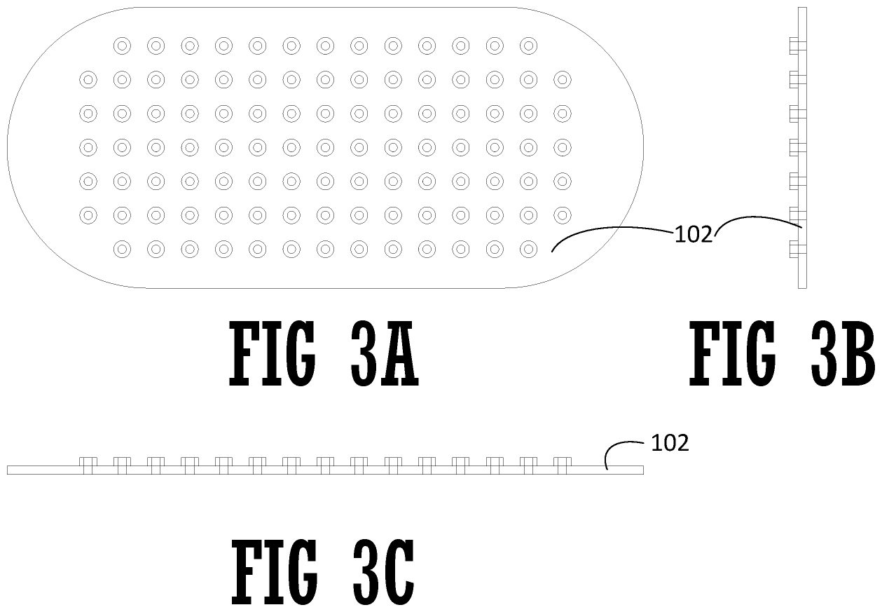

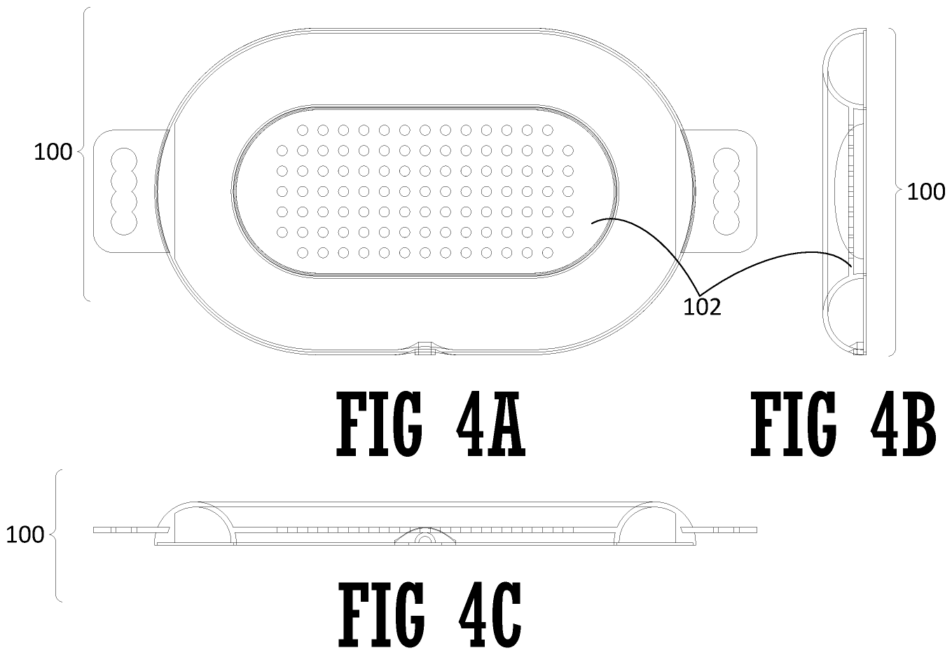

### DETAILED DESCRIPTION OF THE PREFERRED EMBODIMENTS

The embodiments of the Floatable Support for Metal Detection 100 are comprised of a circular or oval support 101, a screen 102, and a pair of skids 103.

The circular or oval support 100 comprises a tube or cylinder formed from durable and highly puncture resistant polymeric material. In one embodiment, the polymeric material is polypropylene. The circular or oval support comprises handles and forms a ballast port 104. The polymeric material is ⅛-inch-thick in the main portion of the circular or oval support. The polymeric material is ¼-inch-thick in around the areas of the handles and the ballast port 104. The circular or oval support comprises two or more handles affixed to the circular or oval support. In one embodiment, an oval support is approximately 33 inches long and 16 inches wide, and the tube or cylinder has an outside diameter of 4 inches. In one embodiment, the circular or oval support comprises a bottom half 201 and a top half each half being mirror images of each other. The bottom half 201 and the top half are mated by thermal forming or adhesive to form the air tight circular or oval support comprises a tube or cylinder.

The screen 102 is comprised of a non-metallic, fabric, or polymeric mesh that forms apertures of ½-inch diameter arranged uniformly over the entire screen 102. The screen 102 is affixed to the circular or oval support and provides a support for items located via the metal detector user. In one embodiment, the screen 102 is approximately ¼ inch thick.

The pair of skids 103 are comprised of essentially an isosceles trapezoid. The skids 103 are affixed to the bottom of the circular or oval support to provide a low friction surface to slide the Floatable Support for Metal Detection. In one embodiment, the pair of skids are approximately 21 inches long and 1 inch wide with a thickness of ¼ inch.

What is claimed is:

1. A floatable support for metal detection comprised of a circular or oval support, a screen, and a pair of skids.
